(19) United States
(12) Patent Application Publication
(10) Pub. No.: US 2025/0354053 A1
(43) Pub. Date: Nov. 20, 2025

(54) IN-SITU HYDROGEN GENERATION IN OIL AND GAS RESERVOIRS

(71) Applicant: SAUDI ARABIAN OIL COMPANY, Dhahran (SA)

(72) Inventors: Harun ATES, Houston, TX (US); Sampath K. BOMMAREDDY, Sugar Land, TX (US)

(73) Assignee: SAUDI ARABIAN OIL COMPANY, Dhahran (SA)

(21) Appl. No.: 18/665,278

(22) Filed: May 15, 2024

(51) Int. Cl. C09K 8/80; C01B 3/26

(52) U.S. Cl. CPC C09K 8/80; C01B 3/26; C01B 2203/0277; C01B 2203/06; C01B 2203/085; C01B 2203/1058; C01B 2203/1241

(57) ABSTRACT

Methods and systems for in-situ hydrogen production in a hydraulically fractured reservoir that includes injecting a mixture of a catalyst and proppant into at least one horizontal borehole in a hydraulically fractured reservoir, wherein said catalyst is capable of catalyzing a reaction to convert one or more hydrocarbon to a hydrogen gas, heating a hydraulically fractured region surrounding the at least one borehole to a temperature sufficient to result in the production of hydrogen gas from hydrocarbon in the reservoir, and converting and extracting the hydrogen gas from the hydraulically fractured reservoir.

### FIELD OF THE DISCLOSURE

The present disclosure relates generally to processes and systems for generating hydrogen and, more particularly, to processes and systems for generating hydrogen in oil and gas reservoirs.

### BACKGROUND OF THE DISCLOSURE

The oil and gas industry is under pressure to become more sustainable, especially with regards to carbon emission and provide sustainable and clean energy. Hydrogen gas is potentially a green energy source that can be produced from processes such as the electrolysis of water with electrical power and from reforming fossil fuels such as natural gas. Hydrogen from natural gas is primarily produced in on-surface (above-ground) facilities with steam methane reforming (SMR) technology. The SMR produces a syngas, that includes a mixture of hydrogen gas and carbon dioxide and the carbon dioxide is then separated and either released to the atmosphere, which is undesirable, or compressed and stored, which can be energy intensive. The hydrogen produced with by product carbon dioxide is commonly referred to as “grey” hydrogen.

Another sustainability technology is carbon capture and sequestration. To accomplish this, carbon dioxide from a product stream is separated from other gases, such as hydrogen gas, and compressed prior to sending to an underground storage facility, like a saline aquifer or being used for enhanced oil recovery within the existing reservoirs. The hydrogen obtained from capture and sequestration of carbon dioxide is called “blue” hydrogen. One of the drawbacks for the blue hydrogen process is the energy intensity required for capturing the carbon dioxide and compressing it for transport and storage. Storage and transportation of hydrogen gas is another major cost.

Subsurface hydrogen generation, also referred to as in-situ hydrogen generation, offers a potential solution to problems associated with both grey and blue hydrogen. Subsurface hydrogen generation produces hydrogen by converting methane to hydrogen and retains much of the greenhouse gases like carbon dioxide in the reservoir. Subsurface hydrogen generation typically involves two well-known and widely used industrial processes: thermal enhanced oil recovery (TEOR) to increase reservoir temperature and steam methane reforming (SMR) to convert methane to hydrogen.

Traditional TEOR for heavy oil reservoirs involves heating cycles accomplished by steam injection, steam flooding, steam-assisted gravity drainage, or in-situ combustion to heat the oil in the reservoir. Downhole heaters (electrical or electromagnetic) have also been tested to increase oil temperature. Heating the oil in TEOR reduces oil viscosity, vaporizes volatile components of the oil, and improves recovery. Steam assisted heating processes are better suited and applied for shallow and thick reservoirs because the heat loss from the wellbore and to the over/under burden is limited. It is possible to use downhole steam generators for deeper reservoirs, but these generators are not commonly used because of high maintenance costs and combustion control problems downhole. Furthermore, as depth increases, the reservoir pressure increases and the latent heat of the steam decreases. Thus, steam processes are typically not applied to deep reservoirs. In-situ combustion using air or oxygen injection is one of the most widely used enhanced oil recovery techniques for heavy oil recovery. But a main challenge in this technique is controlling the flood front.

Thermal stimulation of unconventional shale reservoirs has not been widely developed for two major reasons: (1) the producing fluids are largely gas and light oil and (2) they are deep seated in source rocks where heat loss from the wellbore makes injection of steam from the surface uneconomical. Recently, there is a renewed attention to hydrogen gas generation due to climate change concerns. However, currently available techniques hydrogen generation are not green or not economically feasible.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method for in-situ hydrogen production in a hydraulically fractured reservoir is disclosed and includes injecting a mixture of a catalyst and proppant into a horizontal borehole that penetrates the hydraulically fractured reservoir, the catalyst being capable of catalyzing a reaction to convert one or more hydrocarbons to a hydrogen gas, heating a hydraulically fractured region surrounding the horizontal borehole to a temperature sufficient to result in the production of hydrogen gas from hydrocarbons present within in the hydraulically fractured reservoir, and converting and extracting the hydrogen gas from the hydraulically fractured reservoir.

According to another embodiment consistent with the present disclosure, a system for in-situ hydrogen production in a hydraulically fractured reservoir is disclosed and includes a vertical wellbore extending from a wellhead and including a horizontal borehole extending therefrom and penetrating the hydraulically fractured reservoir, a mixture of a catalyst and a proppant conveyed into the horizontal borehole, the catalyst being capable of catalyzing a reaction to convert one or more hydrocarbons to a hydrogen gas, a heat injection system operable to heat a hydraulically fractured region surrounding the horizontal borehole to a temperature sufficient to result in the production of hydrogen gas from hydrocarbon in the reservoir, and a hydrogen gas extraction system operable to extract hydrogen gas from the hydraulically fractured reservoir.

According to another embodiment consistent with the present disclosure, another method for in-situ hydrogen production in a hydraulically fractured reservoir is disclosed and includes injecting a mixture of a catalyst and proppant into a first horizontal borehole and a second horizontal borehole, wherein the first and second horizontal boreholes penetrate the hydraulically fractured reservoir and are vertically offset from one another, the catalyst being capable of catalyzing a reaction to convert one or more hydrocarbons to a hydrogen gas, during a heating cycle, heating the hydraulically fractured region surrounding one of the first and second horizontal boreholes to a temperature sufficient to result in the production of hydrogen gas from hydrocarbons present within in the region surrounding the one of the first and second horizontal boreholes, and during a production cycle, extracting the hydrogen gas from the hydraulically fractured region surrounding the other of the first and second horizontal boreholes, and alternating the heating and production cycles of the first and second horizontal boreholes such that when the first horizontal borehole is in the heating cycle, the second horizontal borehole is in the production cycle and when the first horizontal borehole is in the production cycle, the second horizontal borehole is in the heating cycle.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic illustration of an in-situ hydrogen generation system, in accordance with embodiments of the present disclosure.

FIG. 2 is a representation of heat transfer to fractures and rocks in a hydraulically fractured reservoir, in accordance with embodiments of the present disclosure.

FIG. 3 is another schematic illustration of an in-situ hydrogen generation system, in accordance with embodiments of the disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to processes and systems for generating hydrogen and, more particularly, to processes and systems for generating hydrogen in oil and gas reservoirs.

Embodiments of the disclosure are directed to processes and systems for in-situ hydrogen generation by thermal stimulation of an oil and gas reservoir, such as a hydraulically fractured unconventional well, which may include an unconventional shale reservoir. Aspects of the process and system produce a high purity hydrogen stream while containing carbon dioxide within the reservoir resulting in significant cost savings and reduction in carbon footprint compared to traditional hydrogen production methods and may provide higher concentrations of hydrogen within the reservoir and produced gas. Embodiments include periodic heat injection (puff) and hydrogen enriched gas production (huff) cycles applied to hydraulically fractured unconventional wells. Hence, the embodiments described herein may be referred to as “thermal huff and puff” embodiments.

Embodiments of the processes and systems described herein maximize the use and benefits of a plurality of hydrogen gas generation techniques including, but not limited to, steam methane reforming (SMR), autothermal reforming (ATR), water gas shift reaction (WGSR), and catalytic cracking for in-situ hydrogen gas production in a reservoir. Embodiments may also include the benefit of functioning as an enhanced oil recovery (EOR) technique, which enhances mobility and recovery of hydrocarbons in the reservoir and may also be applied to depleted (or nearly depleted) unconventional wells.

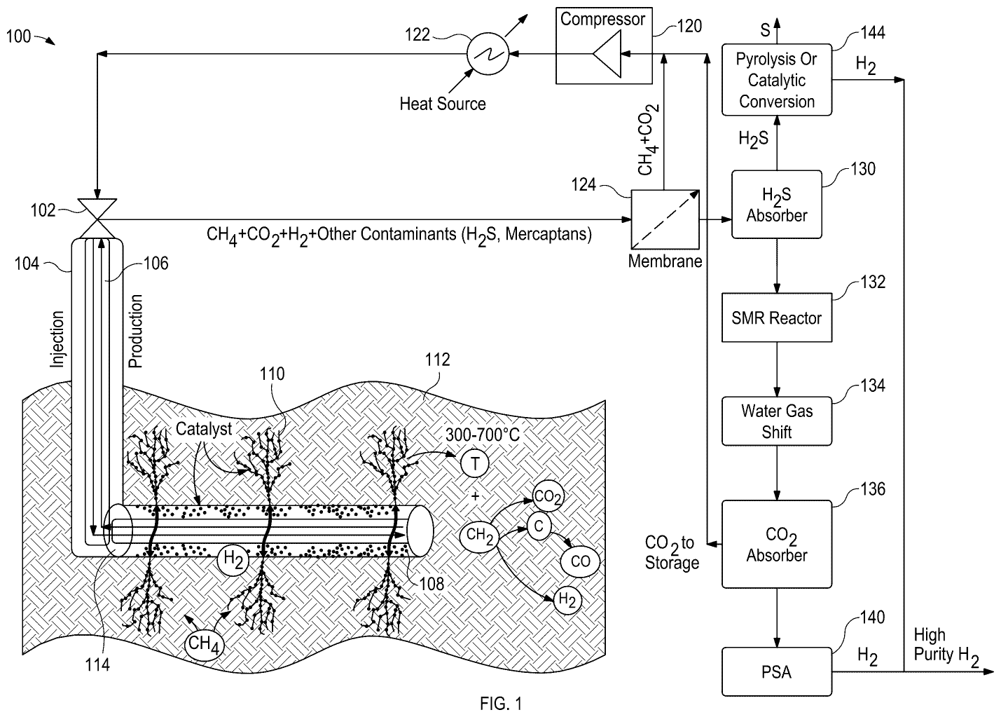

With reference to FIG. 1, embodiments of the disclosure may be implemented in a hydraulically fractured well system 100, such as a hydraulically fractured unconventional well including a wellhead 102, a wellbore 104 extending from the wellhead 102, and associated down hole conduits or piping 106 (e.g., strings of casing, liner, production tubing, etc.). As illustrated, the wellbore 104 may extend substantially vertically from the wellhead 102, but eventually transition into a horizontal borehole 108. Portions of the horizontal borehole 108 may have been previously hydraulically fractured (“fracked”), thus resulting in a myriad of fractures 110 extending radially outward from the horizontal borehole 108. In embodiments, a commercially available catalyst for hydrogen gas cracking may be injected into the horizontal borehole 108 together with a proppant during the hydraulic fracturing process. The catalyst and proppant mixture may be injected into the well using conventional techniques as are utilized in hydraulic fracturing operations.

Examples of the catalysts that may be used in the well system 100 include, but are not limited to, an iron-based catalyst, a cobalt-based catalyst, a nickel-based catalyst, or a combination of other alloys. The catalyst surface should have affinity for the molecular adsorption mechanism, where methane is first adsorbed on the catalyst surface and then dissociates following a series of stepwise surface dehydrogenation reactions thereby releasing hydrogen gas. The size of the catalyst particles may be smaller than that of the proppant to fill up the space in between proppant within the fractures 110 formed in the surrounding rock 112. Proppants can be specified in grain diameter sizes of less than 1/16 inches, and smaller sizes are intended to reach closer to the ends of the fractures. Some common proppant mesh sizes include 16/20, 20/40, 30/50, 40/70, and 100. Treatments may use one size or a multitude of sizes during pumping. Catalysts size may be selected to be smaller than the proppant sizes, and smaller catalyst sizes may be advantageous since it will increase the surface area of catalyst to reach with methane. The mixture ratio of proppant and catalyst particles (which are inert) may be based on the operating conditions of the well, the composition of the reservoir hydrocarbons, and the reservoir temperature and pressure.

Once the hydraulic fractures 110 are generated and backflow is completed, the horizontal borehole 108 may also be filled with the catalyst particles, the proppant, or a catalyst with proppant mixture, in a manner similar to conventional gravel packing of horizontal wells, and depending on the volume of catalyst needed. In embodiments, a screen/filter 114 may be positioned in the horizontal borehole 108 to prevent back flow of catalyst during the production cycle, i.e., the huff cycle. The openings (apertures) in the screen 114 should be small enough to prevent the movement of the catalyst towards the wellhead 102.

Embodiments of the process utilize two cycles: a “puff” cycle, during which heat is injected into the well (i.e., heat injection cycle), and a “huff” cycle, during which hydrogen is produced (i.e., production cycle).

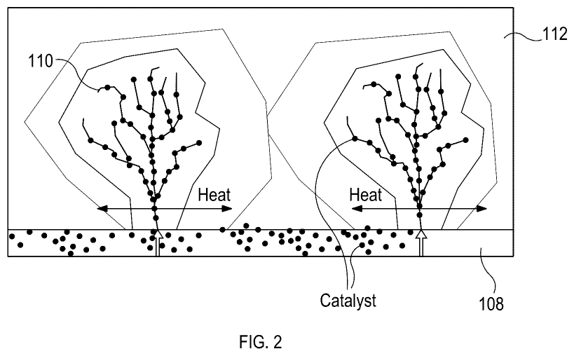

With reference to FIG. 2, during the puff cycle, heat is injected into the well for a duration sufficient to raise the temperature within a hydraulically fractured region (stimulated rock volume) to a temperature sufficient to start hydrogen gas generation reactions. In embodiments, heat is injected into the well to raise the temperature to at least about 300° C. and in other embodiments, the temperature is in a range between about 300° C. and about 700° C. The time required to reach these temperatures may depend on the types of heating mechanisms used. Heat injection may be accomplished with a heat injection system configured to heat the hydraulically fractured region with at least one of in-situ combustion, steam injection, an electrical downhole heater, an electromagnetic downhole heaters and combinations thereof. For in-situ combustion, oxygen is injected into the well and allowed to combust with methane in an exothermic reaction. The reaction for the heat generation from in-situ combustion may be written as:

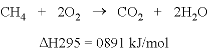

Injected heat will increase the temperature of the volume of rock 112 surrounding the fractures 110 to start the catalytic hydrogen gas generation reactions such as SMR, WGSR and ATR. There may also be a simple disassociation reaction that occurs where CH₄ disassociates into C+2H₂; similar to a pyrolysis technique.

During the hydrogen gas generating reactions, solid carbon (coke) may become deposited on the catalysts thereby decreasing their efficiency. To address this potential issue, embodiments include removing coke deposited on catalysts using one or more coke gasification reactions (CGR), such as illustrated below in equations 1, 2, and 3:

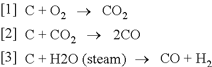

In an embodiment, coke may be removed by combusting the carbon with air/oxygen to produce carbon dioxide (Eq. 1). In another embodiment, coke may be removed by injecting carbon dioxide to produce carbon monoxide (Eq. 2). In another embodiment, coke may be removed with steam thereby generating additional hydrogen gas and carbon monoxide (Eq. 3). The steam process might be especially useful in cases of electrical heating (dry catalytic cracking). Removing coke from the catalyst improves the life of the well because the catalyst's ability to generate hydrogen gas will reduce over time due to the coke deposition. The cyclic nature of the presently described huff and puff procedure resolves this issue and provides long-term use of the catalyst. Additionally, generated carbon monoxide or carbon dioxide from the coke gasification reactions will move into the rock formation, which functions as a natural storage for these gases without requiring energy intensive carbon capture techniques. In some embodiments, carbon monoxide can further react with formation water providing additional hydrogen gas through WGSR.

In embodiments, the heated reservoir is allowed to incubate for a duration sufficient to result in the production of hydrogen gas to a desired level prior to extraction. In an embodiment, the desired level of hydrogen gas is determined by the percent hydrogen gas in the extracted fluid, which may be in a liquid or gaseous form. In an embodiment, the desired level of hydrogen gas is hydrogen at a concentration of at least 20%-50% by volume of the extract fluid. Heat may be continuously injected during the puff cycle. Any time duration between huff and puff cycles may depend on the type of heat injection mechanism used; e.g., electrical, air/oxygen, or steam. Various factors may be considered to optimize this process.

The huff cycle is the production cycle when hydrocarbons flow thru the hydraulic fractures 110 and the wellbore 104 filled with catalyst and proppant to produce hydrogen gas. Catalytic cracking of methane produces hydrogen gas for the production stream while depositing solid carbon (coke) over the surface of the catalyst. In some applications, the wellbore 104 may be at a positive pressure, thereby allowing the gas to be extracted through positive pressure extraction. In other applications, or in addition thercto, one or more pumps may be used to help extract the gas. As explained in above with respect to the puff cycle, this coke may be removed with a CGR. The produced gas may include a mixture of hydrogen gas, carbon dioxide, methane, other hydrocarbon components, as well as some impurities such as hydrogen sulfide.

Referring again to FIG. 1, the produced gas may then be extracted from the well with a gas extraction system, which may include the downhole piping 106 as well as the gas separation and processing components described herein. For example, the produced gas from the production well may be separated using commercially available systems and techniques to ultimately result in high purity hydrogen gas. In an embodiment, the produced gas may include a sour gas, which may be passed through a separator 124 in fluid communication with the wellhead. The separator 124 may comprise, for example, a commercially available membrane separator. In embodiments, a portion of the methane and carbon dioxide from the separator 124 may be used in other purposes. For example, these gases may be mixed with oxygen (or oxygen containing air) and passed through a compressor 120 and an optional heat source 122 before being injected back into the well for in-situ combustion. These gases may also be used for heat generation for other processes such as for SMR, or used to generate electricity, which may be used to support electrical heating of the reservoir formation.

In embodiments, the hydrogen sulfide may be separated from other components in the gas in a hydrogen sulfide absorber 130. Methane and carbon dioxide carried in the gas may pass through one or more reactors or absorbers, such as a SMR reactor 132, a WGSR reactor 134, a carbon dioxide absorber 136, and a pressure swing adsorption (PSA) process 140 to yield the high purity hydrogen (H₂) gas. Carbon dioxide from the carbon dioxide absorber 136 may be stored or mixed with gas that is injected back into the well. Hydrogen sulfide from the hydrogen sulfide absorber may undergo pyrolysis or catalytic conversion in a converter 144 to yield sulfur(S) and H₂ gas. The sulfur may be stored and the hydrogen gas may be conveyed to the high purity hydrogen gas stream. In some applications, to qualify as “high-purity” hydrogen gas, the purity of the hydrogen gas may range between about 90% and about 99.99%.

Due to tight nature of the rock in some reservoir types, hydrogen gas migration will not be an issue as it is for conventional reservoirs. In embodiments, generated hydrogen gas may be stored within the stimulated reservoir volume (SRV), which is a major cost savings compared to common hydrogen gas subsurface storage techniques (i.e. salt domes, depleted gas or saline aquifers). In some embodiments, the tight space between hydraulic fractures may improve the efficiency of reaching the high temperatures needed for hydrogen gas generation as compared to conventional reservoirs where controlling temperature front and heat loss can be difficult.

The cyclic nature of the presently described huff and puff process can be matched with the cyclic nature of market demand for hydrogen gas. During periods of low demand, for example, wells can be put into the puff cycle, and during periods of high demand, wells may be transitioned to the huff cycle.

In some embodiments, kerogen and other heavier hydrocarbon components may crack into smaller components when the temperature in the reservoir reaches around 700° C. near fracture faces. This cracking will provide major advantages including decreasing fluid viscosity thereby increasing the mobility of fluids towards the wellbore, increasing the porosity and permeability of the cracked hydrocarbons further enhancing flow towards wellbore, and improving performance of the well over time as more and more thermal cycles applied.

In embodiments, multiple hydrogen gas generation mechanisms are utilized to maximize hydrogen gas production. For example, in embodiments, SMR and WGSR are used away from the fracture face, ATR is employed near the fracture face, CCR is employed within the fractures 110 and the wellbore 104, and CGR may also be employed within the 110 fractures and the wellbore 104. When determining which mechanism is employed, well characteristics and availability of steam and other economic factors may determine which methodology is employed. Some or all the process may be active, depending on the type of heat injected (i.e., steam, in-situ combustion, or electrical).

During the puff cycle, the generated carbon dioxide that results from SMR, WGSR, and ATR reactions may also have an enhanced oil recovery impact. Carbon dioxide from these reactions may enhance oil recovery because the addition of carbon dioxide increases the overall pressure of an oil reservoir thereby forcing the oil towards the wellbore 104. Carbon dioxide may also blend with the oil, improving its mobility and so allowing it to flow more easily.

Hydrogen purity in the produced stream will increase as the huff and puff cycles increase. Once a desired concentration is reached, hydrogen enhanced methane gas can be delivered to the market using existing pipelines without a need to upgrade pipelines as the world transitions to a hydrogen economy.

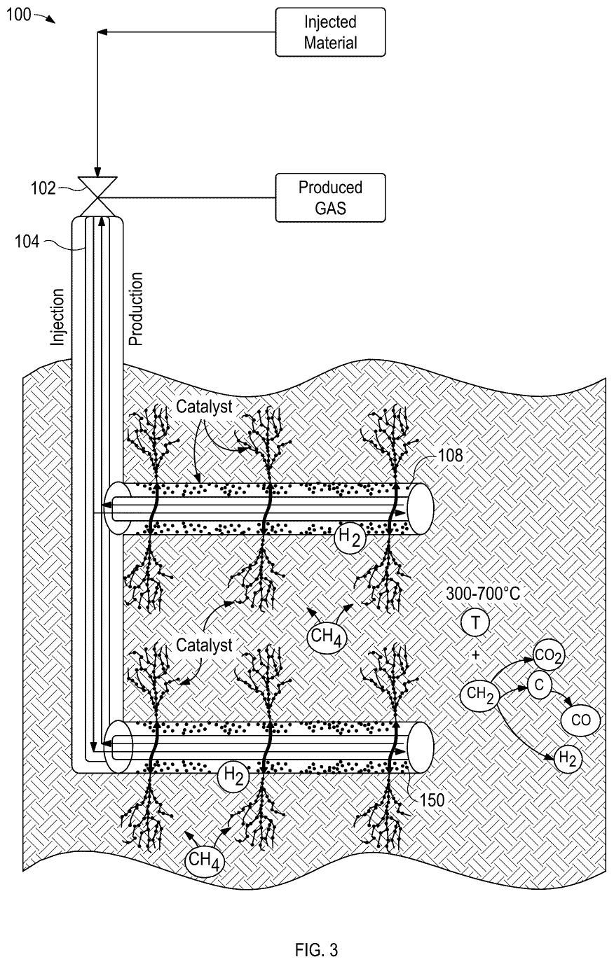

With reference to FIG. 3, embodiments may utilize two or more horizontal boreholes, such as the first horizontal borehole 108 and a second horizontal borehole 150, which is vertically offset from the first horizontal borehole 108 and also in fluid communication with the wellbore 104. The two or more horizontal boreholes 108, 150 may be stacked one on top of the other. In embodiments, while one of the horizontal boreholes 108, 150 is in the puff cycle, the other horizontal borehole 108, 150 may be in the huff cycle. The horizontal boreholes 108, 150 may alternate cycles (i.e., the first borehole 108 may transition from the huff cycle to the puff cycle while the second borehole 150 transitions from the puff cycle to the huff cycle) to maximize hydrogen production volumes and efficiency.

Embodiments disclosed herein include:

A. A method for in-situ hydrogen production in a hydraulically fractured reservoir, the method including injecting a mixture of a catalyst and proppant into a horizontal borehole that penetrates the hydraulically fractured reservoir, the catalyst being capable of catalyzing a reaction to convert one or more hydrocarbons to a hydrogen gas, heating a hydraulically fractured region surrounding the horizontal borehole to a temperature sufficient to result in the production of hydrogen gas from hydrocarbons present within in the hydraulically fractured reservoir, and converting and extracting the hydrogen gas from the hydraulically fractured reservoir.

B. A system for in-situ hydrogen production in a hydraulically fractured reservoir, the system including a vertical wellbore extending from a wellhead and including a horizontal borehole extending therefrom and penetrating the hydraulically fractured reservoir, a mixture of a catalyst and a proppant conveyed into the horizontal borehole, the catalyst being capable of catalyzing a reaction to convert one or more hydrocarbons to a hydrogen gas, a heat injection system operable to heat a hydraulically fractured region surrounding the horizontal borehole to a temperature sufficient to result in the production of hydrogen gas from hydrocarbon in the reservoir, and a hydrogen gas extraction system operable to extract hydrogen gas from the hydraulically fractured reservoir.

C. A method for in-situ hydrogen production in a hydraulically fractured reservoir, the method including injecting a mixture of a catalyst and proppant into a first horizontal borehole and a second horizontal borehole, wherein the first and second horizontal borcholes penetrate the hydraulically fractured reservoir and are vertically offset from one another, the catalyst being capable of catalyzing a reaction to convert one or more hydrocarbons to a hydrogen gas, during a heating cycle, heating the hydraulically fractured region surrounding one of the first and second horizontal boreholes to a temperature sufficient to result in the production of hydrogen gas from hydrocarbons present within in the region surrounding the one of the first and second horizontal borcholes, and during a production cycle, extracting the hydrogen gas from the hydraulically fractured region surrounding the other of the first and second horizontal borcholes, and alternating the heating and production cycles of the first and second horizontal borcholes such that when the first horizontal borehole is in the heating cycle, the second horizontal borehole is in the production cycle and when the first horizontal borehole is in the production cycle, the second horizontal borehole is in the heating cycle.

Each of embodiments A, B, and C may have one or more of the following additional elements in any combination: Element 1: wherein the catalyst is capable of catalyzing at least one of a steam methane reforming (SMR) reaction, an autothermal reforming (ATR) reaction, a water gas shift reaction (WGSR), and combinations thereof. Element 2: wherein the catalyst is an iron based catalyst, a cobalt based catalyst, a nickel based catalyst, or a catalyst based on an alloy that includes at least one of iron, cobalt, and nickel. Element 3: wherein the catalyst exhibits a first particle size and the proppant exhibits a second particle size larger than the first catalyst size. Element 4: wherein the hydraulically fractured region is heated to a temperature of at least about 300° C. Element 5: wherein the hydraulically fractured region is heated to a temperature in a range from about 300° C. to about 700° C. Element 6: wherein heating the hydraulically fractured region includes injecting heat through at least one of in-situ combustion, steam injection, electrical downhole heaters, electromagnetic downhole heaters or combinations thereof. Element 7: further comprising allowing the heated hydraulically fractured region to incubate for a duration sufficient to produce a hydrogen gas in an extracted gas stream at a desired concentration level. Element 8: wherein the desired concentration level is between about 20% and 50% by volume. Element 9: wherein the horizontal borehole comprises a first horizontal borehole and a second horizontal borehole also penetrates the hydraulically fractured reservoir. Element 10: wherein the reaction to convert the one or more hydrocarbons to a hydrogen gas results in coke formation on the catalyst, the method further comprising removing coke from the catalyst. Element 11: wherein removing coke from the catalyst comprises injecting at least one of air, oxygen, carbon dioxide, steam, or combinations thereof into the horizontal borehole.

Element 12: wherein the catalyst is capable of catalyzing at least one of a steam methane reforming (SMR) reaction, an autothermal reforming (ATR) reaction, a water gas shift reaction (WGSR), and combinations thereof. Element 13: wherein the catalyst is an iron based catalyst, a cobalt based catalyst, a nickel based catalyst, or a catalyst based on an alloy that includes at least one of iron, cobalt, and nickel. Element 14: wherein the catalyst exhibits a first particle size and the proppant exhibits a second particle size larger than the first catalyst size. Element 15: wherein heat injection system includes at least one of in-situ combustion, steam injection, electrical downhole heaters, electromagnetic downhole heaters or combinations thereof.

By way of non-limiting example, exemplary combinations applicable to A, B, and C include: Element 7 with Element 8; and Element 10 with Element 11.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such. While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method for in-situ hydrogen production in a hydraulically fractured reservoir, the method comprising:
injecting a mixture of a catalyst and proppant into a horizontal borehole that penetrates the hydraulically fractured reservoir, the catalyst being capable of catalyzing a reaction to convert one or more hydrocarbons to a hydrogen gas;
heating a hydraulically fractured region surrounding the horizontal borehole to a temperature sufficient to result in the production of hydrogen gas from hydrocarbons present within in the hydraulically fractured reservoir; and
converting and extracting the hydrogen gas from the hydraulically fractured reservoir.

2. The method of claim 1, wherein the catalyst is capable of catalyzing at least one of a steam methane reforming (SMR) reaction, an autothermal reforming (ATR) reaction, a water gas shift reaction (WGSR), and combinations thereof.

3. The method of claim 1, wherein the catalyst is an iron based catalyst, a cobalt based catalyst, a nickel based catalyst, or a catalyst based on an alloy that includes at least one of iron, cobalt, and nickel.

4. The method of claim 1, wherein the catalyst exhibits a first particle size and the proppant exhibits a second particle size larger than the first catalyst size.

5. The method of claim 1, wherein the hydraulically fractured region is heated to a temperature of at least about 300° C.

6. The method of claim 1, wherein the hydraulically fractured region is heated to a temperature in a range from about 300° C. to about 700° C.

7. The method of claim 1, wherein heating the hydraulically fractured region includes injecting heat through at least one of in-situ combustion, steam injection, electrical downhole heaters, electromagnetic downhole heaters or combinations thereof.

8. The method of claim 1, further comprising allowing the heated hydraulically fractured region to incubate for a duration sufficient to produce a hydrogen gas in an extracted gas stream at a desired concentration level.

9. The method of claim 8, wherein the desired concentration level is between about 20% and 50% by volume.

10. The method of claim 1, wherein the horizontal borehole comprises a first horizontal borehole and a second horizontal borehole also penetrates the hydraulically fractured reservoir.

11. The method of claim 1, wherein the reaction to convert the one or more hydrocarbons to a hydrogen gas results in coke formation on the catalyst, the method further comprising removing coke from the catalyst.

12. The method of claim 11, wherein removing coke from the catalyst comprises injecting at least one of air, oxygen, carbon dioxide, steam, or combinations thereof into the horizontal borehole.

13. A system for in-situ hydrogen production in a hydraulically fractured reservoir, the system comprising:
a vertical wellbore extending from a wellhead and including a horizontal borehole extending therefrom and penetrating the hydraulically fractured reservoir;
a mixture of a catalyst and a proppant conveyed into the horizontal borehole, the catalyst being capable of catalyzing a reaction to convert one or more hydrocarbons to a hydrogen gas;
a heat injection system operable to heat a hydraulically fractured region surrounding the horizontal borehole to a temperature sufficient to result in the production of hydrogen gas from hydrocarbon in the reservoir; and
a hydrogen gas extraction system operable to extract hydrogen gas from the hydraulically fractured reservoir.

14. The system of claim 13, wherein the catalyst is capable of catalyzing at least one of a steam methane reforming (SMR) reaction, an autothermal reforming (ATR) reaction, a water gas shift reaction (WGSR), and combinations thereof.

15. The system of claim 13, wherein the catalyst is an iron based catalyst, a cobalt based catalyst, a nickel based catalyst, or a catalyst based on an alloy that includes at least one of iron, cobalt, and nickel.

16. The system of claim 13, wherein the catalyst exhibits a first particle size and the proppant exhibits a second particle size larger than the first catalyst size.

17. The system of claim 13, wherein heat injection system includes at least one of in-situ combustion, steam injection, electrical downhole heaters, electromagnetic downhole heaters or combinations thereof.

18. A method for in-situ hydrogen production in a hydraulically fractured reservoir, the method comprising:
injecting a mixture of a catalyst and proppant into a first horizontal borehole and a second horizontal borehole, wherein the first and second horizontal boreholes penetrate the hydraulically fractured reservoir and are vertically offset from one another, the catalyst being capable of catalyzing a reaction to convert one or more hydrocarbons to a hydrogen gas;
during a heating cycle, heating the hydraulically fractured region surrounding one of the first and second horizontal boreholes to a temperature sufficient to result in the production of hydrogen gas from hydrocarbons present within in the region surrounding the one of the first and second horizontal boreholes; and
during a production cycle, extracting the hydrogen gas from the hydraulically fractured region surrounding the other of the first and second horizontal boreholes; and
alternating the heating and production cycles of the first and second horizontal boreholes such that when the first horizontal borehole is in the heating cycle, the second horizontal borehole is in the production cycle and when the first horizontal borehole is in the production cycle, the second horizontal borehole is in the heating cycle.
